(19) United States
(12) Patent Application Publication
(10) Pub. No.: US 2009/0229492 A1
(43) Pub. Date: Sep. 17, 2009

(54) Cement-containing compositions and method of use

(75) Inventor: Peter Shelley Mills, Stamping Grounds, KY (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: Minova International Limited, Witan Way, Witney (GB)

(21) Appl. No.: 12/297,919

(22) PCT Filed: Apr. 25, 2007
(86) PCT No.: PCT/GB07/01503

§ 371 Date: May 1, 2009

(30) Foreign Application Priority Data
Apr. 25, 2006 (GB) 0608177.2

(51) Int. Cl. C04B 38/10; C04B 7/02

(52) U.S. Cl. 106/680; 106/735

(57) ABSTRACT

The invention provides a system comprising two components to be mixed together to form a settable cementitious composition wherein a first component comprises: (a) Portland cement; (b) calcium sulphate; and (c) water in a weight ratio of water to Portland cement and calcium sulphate solids of from 0.5:1 to 5:1; and a second component comprises: (d) a water soluble silicate; and (e) water, in a weight ratio of water to silicate solids of from 1.5:1 to 25:1; which cementitious composition has a higher early strength than known compositions.

### CROSS-REFERENCE TO RELATED APPLICATION

This Application is a Section 371 National Stage Application of International Application No. PCT/GB2007/001503, filed Apr. 25, 2007, the content of which is hereby incorporated by reference in its entirety

### FIELD OF THE INVENTION

This invention relates to cement-containing compositions, to a method for their preparation and to a method in which they are used.

### BACKGROUND OF THE DISCLOSURE

Cement-containing compositions, sometimes referred to as grouts, have been extensively used in mines principally to provide support. A mine roof, once exposed, will normally lower to some extent and it has therefore been the practice to place passive supports beneath it to control the lowering. These supports have to be able to deform whilst maintaining a good load bearing capacity, typically at least a few hundred pounds per square inch (p.s.i.). If they cannot deform, they may cause structural damage by either punching a hole in the roof or floor of the mine or else fail in a brittle manner with rapid loss of load bearing capability. Traditionally this requirement has been met with the use of high water content grouts, pumped into a flexible container, sometimes referred to as a bag, which after the cement has set deforms plastically under load. The cement has previously been of a type that forms a considerable amount of Ettringite quickly, for example, materials sold under the trade marks Tekpak, Hydropack and Aquapak. The Ettringite-forming grouts have been based on mixtures of aluminous cement, calcium sulphate and a source of lime. Usually the aluminous cement is pumped as a slurry separate from the calcium sulphate/lime mixture in order to provide a two component grout with an extended working life for each component. Combining the two components causes setting within a few minutes. Very high water/solids ratios have been employed so that the slurries are of low viscosity in order that they may be pumped significant distances e.g. up to 10 kilometres through small diameter pipelines to the point of use.

It has also been proposed previously to employ the reaction between an alkali metal silicate and Portland cement to produce a load bearing material for providing support in mines.

International patent publication WO 02/44100 discloses a cementitious composition comprising a first component comprising a Portland cement and water and preferably a retarder for the cement hydration reaction and preferably also a suspension agent to prevent solids settling out and a second component comprising an aqueous silicate solution and the supply of the components to the place of use, where they are mixed to form a grout and the supply of the grout so formed to a flexible container capable of deforming to the contours of the mine surface. This composition provides support in a mine whilst reducing or avoiding the use of aluminous cements which are relatively expensive. It also provides a grout which is fluid for sufficient time to enable the grout, when supplied to a flexible container, to deform the container to the contours of the mine surface. However, there is still a need for a cementitious composition having a still faster rate of strength development which reduces or avoids the use of relatively expensive aluminous cements.

### SUMMARY

According to the invention there is provided a system comprising two components to be mixed together to form a settable cementitious composition wherein a first component comprises:
(a) Portland cement;
(b) calcium sulphate; and
(c) water in a weight ratio of water to Portland cement and calcium sulphate solids of from 0.5:1 to 5:1; and a second component comprises:
(d) a water soluble silicate; and
(e) water, in a weight ratio of water to silicate solids of from 1.5:1 to 25:1.

According to the present invention there is also provided a settable cementitious composition which is fluid for sufficient time to be suitable for use in a flexible container to provide support in a mine wherein said composition comprises:

(i) Portland cement;
(ii) calcium sulphate;
(iii) a water soluble silicate; and
(iv) water in an amount to provide a water to solids weight ratio of at least about 1.2:1.

According to another aspect of the invention there is provided a method of producing a settable composition which is fluid for sufficient length of time to be suitable for use in a flexible container for providing support in mine, which method comprises the steps of:

providing a system according to the invention; and
mixing the first and second components of the system together to form a settable composition having a water to solids weight ratio of at least about 1.2:1.

According to a further aspect of the present invention there is provided a method of providing support in a mine which method comprises providing first and second components as hereinbefore defined at a point of use in a mine, mixing the components to form a settable composition and employing the settable composition to give support in the mine. The first and second components are optionally provided at the point of use in a mine by pumping the components to the point of use.

### PREFERRED EMBODIMENT

The advantages of the system, composition and methods of the invention include that they each provide a settable composition which has a higher early strength than known compositions. A further advantage of the invention is that the cost of ingredients is less because less Portland cement is required.

The components of the invention can be provided in the form of two streams of high water content (a slurry containing the Portland cement and calcium sulphate and a solution containing the silicate) to be mixed. The composition obtained from mixing the two components is suitable for use as a mine support with a flexible container and results in improved contact with the mine roof and therefore improved support characteristics. In addition it has been found advantageous to include a suspension agent in the cement slurry. This allows delivery pipes to be left full of slurry under static conditions for many hours and remain pumpable. Preferably the first and/or second component of the invention or the composition according to the invention comprises a suspension agent to prevent solids settling out. Preferably the first component comprises the suspension agent. Preferably the suspension agent also facilitates pumpability. The suspension agent is optionally a polysaccharide gum (for example welan gum), bentonite or a finely divided amorphous silica.

The settable composition according to the invention or the settable composition formed by combining the first and second components of the invention preferably has a minimum solids content of at least about 10%, more preferably at least about 12%, most preferably at least about 20% by weight.

The settable composition according to the invention or the settable composition formed by combining the first and second components of the invention preferably has a water to solids weight ratio of at least about 1.2:1, preferably at least about 1.3:1, preferably at least about 1.4:1, preferably at least about 1.5:1, preferably at least about 1.6:1, preferably at least about 1.7:1, preferably at least about 1.8:1, preferably at least about 1.9:1, preferably at least about 2:1, preferably at least about 2.5:1.

The settable composition according to the invention or the first component of the invention preferably comprises Portland cement in an amount from at least about 6%, preferably from at least about 8%, more preferably from at least about 10% wherein the percentage is by weight based on the combined weight of the settable composition or of the settable composition formed by combining the first and second components of the invention, respectively.

The settable composition according to the invention or the first component of the invention preferably comprises calcium sulphate in an amount from at least about 0.5%, preferably from at least about 2% wherein the percentage is by weight based on the combined weight of the settable composition or of the settable composition formed by combining the first and second components of the invention, respectively.

The settable composition according to the invention or the second component of the invention preferably comprises a water soluble silicate in an amount from at least about 2% wherein the percentage is by weight based on the combined weight of the settable composition or of the settable composition formed by combining the first and second components of the invention, respectively.

The term mine in the present specification is intended to include quarries, tunnels and all underground earthworks.

The term Portland cement in the present specification means a cement which contains tricalcium silicate and dicalcium silicate which combined constitute at least 50% by weight of the cement. Portland cement as supplied by the manufacturer contains one or more materials such as gypsum (which is typically present in an amount of about 5% to prevent flash setting) which may be considered to act as a retarder.

The first and/or second component of the invention or the composition according to the invention preferably contains a retarder for the cement hydration reaction. Preferably the first component comprises the retarder. The term retarder for the cement hydration reaction in the present specification refers to a material that is not present in Portland cement as supplied by the manufacturer and which retards the hydration of the cement. A suitable retarder will be well known to a person of skill in the art and optionally includes a gluconate, especially an alkali metal gluconate, for example sodium gluconate.

The first and/or second component of the invention or the composition according to the invention preferably contains a gelling agent to assist in providing early stiffness to the settable composition. The early stiffness particularly is the stiffness of the settable composition (optionally formed by mixing the first and second components of the invention) up to 30 minutes from when the settable composition is formed. The gelling agent preferably assists in providing early stiffness to the settable composition at a low temperature, particularly a temperature below 10° C., e.g. a temperature around 5° C. The gelling agent thus makes the performance of the settable composition less temperature dependent. Any suitable gelling agent which is known to a person of skill in the art may be used. It is preferably hydrated lime.

The term pozzolan is intended to include non aluminous cements such as blast furnace slag, flyash, metakaolin and silica fume.

The term calcium sulphate is intended to include finely ground gypsum, calcium sulphate hemihydrate and anhydrous calcium sulphate (also known as anhydrite). For reasons of economy anhydrous calcium sulphate is usually preferred. Mixtures of calcium sulphate and flyash resulting from the burning of coal with additional limestone may also be used as may by-product forms of calcium sulphate. The calcium sulphate addition is in addition to that normally contained in the Portland cement.

The term pumpable means capable of being pumped by conventional pumps as used in the mining industry. A settable cementitious composition according to the invention is preferably pumpable for at least 4 hours, preferably at least 24 hours, more preferably at least 48 hours, most preferably at least 72 hours, particularly when stored at 15° C. under static conditions.

The term solids in the phrase water to solids ratio refers to both dissolved and undissolved solids.

References to the amount of water in compositions that lose water with passage of time are to the amount of water in the composition immediately after mixing the ingredients together.

The term self levelling is intended to mean that the compositions will flow under their own weight.

The flexible container employed in the present invention may be as described in WO 97/47859 the disclosure of which is hereby incorporated by reference. The published application discloses a container which comprises a tubular member conveniently made of steel having at its ends rubber diaphragms which are capable of being inflated and stressed against the roof and floor of the mine by the introduction of a pumpable load bearing material, the diaphragms being sufficiently flexible to follow the surface irregularities in the roof and floor of the mine.

The amount of water (iv) by weight in the settable composition is preferably from 55% to 85% based on the combined weight of (i), (ii) (iii) and (iv). The amount of water in the system according to the invention or in the settable composition according to the invention preferably includes the amount of water used to dissolve the silicate solids.

The settable composition may optionally contain (v) a further non-aluminous cement. Optionally, the first component of the system of the invention may optionally contain a further non-aluminous cement. A suitable non-aluminous cement is, for example, a blast furnace slag conveniently in ground granulated form known in the art as GGBFS, flyash which may be class C or class F flyash, metakaolin, silica fume or another pozzolan. The amount of which may preferably be up to 35%, preferably up to 20% by weight of the combined weight of the settable composition or the combined weight of the first and second components of the system of the invention. Typical preferred amounts are in the range from 2%, more preferably from 4% to 15% by weight.

The settable composition may optionally contain (vi) a foaming agent. Optionally, the first component of the system of the invention may contain a foaming agent. A suitable foaming agent will be well known to a person of skill in the art and may, for example, include a hydrolised protein, a fatty acid salt (e.g. sodium cocoyl isethionate), an alkyl-aryl sulphonate, an alkyl sulphate, and/or a phenol ethoxylate. The amount of which may preferably be up to 5%, preferably up to 3% by weight of the combined weight of the settable composition or the combined weight of the first and second components of the system of the invention. Typical preferred amounts are in the range from 0.0001%, preferably from 0.001%, more preferably from 0.01% to 5%, preferably to 3%, more preferably to 2% by weight.

The settable composition may optionally contain (vii) a foam stabiliser. Preferably the foam stabilizer (vii) and the foaming agent (vi) are present in the same component. Optionally, the first component of the system of the invention may contain a foam stabiliser. A suitable foaming stabilizer will be well known to a person of skill in the art and may, for example, include a cellulose ether (e.g. hydroxy propyl methyl cellulose) and/or a clay. The amount of which may preferably be up to 5%, preferably up to 3% by weight of the combined weight of the settable composition or the combined weight of the first and second components of the system of the invention. Typical preferred amounts are in the range from 0.0001%, preferably from 0.001%, more preferably from 0.01% to 5%, preferably to 3%, more preferably to 2% by weight.

The settable composition according to the invention is optionally foamed. It has surprisingly been found that a foamed settable composition has a sufficient compressive strength whilst having a lower density. As a result of having a lower density, less of the composition is required to provide support resulting in cost savings.

The method of producing a settable composition according to the invention optionally comprises the step of entraining air in the first and/or second component prior to the step of mixing the first and second components. The step of air entrainment may be performed by agitating the first and/or second component (e.g. by using a high-speed mixer) or by pumping the first and/or second component using an air entrainment pump such as a progressive cavity or snorer pump.

The settable compositions develop a compressive strength as follows:

at 2 hours of at least 20 psi, preferably at least 40 psi;
at one day of at least 200 psi, preferably at least 300 psi; and at 8 days of at least 400 psi, preferably at least 500 psi, more preferably at least 600 psi;
wherein storage is at 20° C.

It will be understood that the abbreviation “psi” as used herein refers to a measurement in pounds per square inch which is equivalent to 703 kg/m². Percentages disclosed herein are percentages calculated by weight unless an alternative method of calculation is mentioned.

Suitable silicates for use in the present invention may be any of those described in U.S. Pat. Nos. 3,672,173; 4,984,933; 3,928,052 and 4,655,837. Preferred silicates are alkali metal silicates and preferred weight ratios of silica to sodium oxide are from 1.5 to 3.3 to 1.

The invention is illustrated by the following Examples which are not intended to limit the scope of the invention. They describe the preparation of fluid settable compositions which are of sufficiently low viscosity (a dynamic viscosity of below about 100 centipoise) immediately after mixing to be able to incorporate additional water and which are flowable or self levelling. The compositions gelled in about 30 seconds, at 12° C. After gelling none of the settable compositions formed in the Examples exhibited bleeding.

### Example 1

The following Example is an Example of the invention. The composition prepared in this Example comprises a relatively high amount of anhydrite.

TABLE 1

| | % in the | | % in |
|---|---|---|---|
| Component A | mix | Component B | the mix |
| Type III Portland cement | 23.22 | 39% solids sodium silicate | 33.96 |
| Type F Flyash | 21.00 | (3.3:1 weight ratio of | |
| Anhydrite | 4.42 | silica/sodium oxide) | |
| Hydrated lime | 0.31 | | |
| Welan gum | 0.05 | | |
| Sodium gluconate | 0.15 | | |
| Water | 50.85 | Water | 66.04 |

Welan gum is a suspension agent to prevent settling out of the cement solids and thereby facilitate pumpability after storage under static conditions. Hydrated lime results in a gel time which is less temperature dependent. Sodium gluconate is a retarder for the hydration reaction of the Portland cement. Type III is a designation for Portland cement used in the USA according to 15 ASTM C150. The amount of flyash based on the total weight of A and B was 11.57%. The amount of calcium sulphate was 2.44% based on the total weight of A and B.

Component A in the form of a slurry and component B in the form of a solution were prepared from the individual ingredients shown in Table 1. Component A was prepared by first blending the Portland cement, Welan gum, flyash, anhydrite, lime and gluconate and the mixture thus formed (which was in the form of a powder) then added to the water. Component A was prepared in this way in all the Examples thus a dry powder was prepared and added to the water.

Component B had an indefinite pumping life and Component A had a pumping life of several days when stored at 15° C. under static conditions (in other words without agitation). Components A and B were mixed together in equal volume to give a fluid self levelling composition to which additional water could be readily incorporated. The water to solids ratio by weight was 2.02:1.

The fluid composition was pumped into a flexible container as described in WO 97/47859 located in a mine to inflate the latter into sealing contact with the contours of the mine roof and floor. A measurement of uniaxial compressive strength was carried out. 100 mm cubes of the set grout were prepared in foamed polystyrene molds and their compressive strength measured at different ages using a standard compressive test machine. This method was used in all the Examples.

The compressive strengths after storage at 20 degrees Centigrade were as follows:

| | | | |
|---|---|---|---|
| 2 | hours | 146 | psi |
| 4 | hours | 314 | psi |
| 24 | hours | 476 | psi |
| 8 | days | 790 | psi; |
| 28 | days | 1103 | psi; and |
| 6 | weeks | 1153 | psi. |

At 6 weeks the specimen yielded in a non brittle manner. To be effective when used as a mine support it is desirable that the compositions yield under load and do not fail in a brittle manner.

### Example 2

This Example described a composition in accordance with WO 02/44100. It contains no additional calcium sulphate and is not according to the invention and is included for comparative purposes only.

TABLE 2

| | % in | | % in |
|---|---|---|---|
| Component A | the mix | Component B | the mix |
| Type III Portland cement | 23.22 | 39% solids sodium silicate | 33.96 |
| Type F Flyash | 25.42 | (3.3:1 weight ratio of | |
| Additional calcium | 0.00 | silica/sodium oxide) | |
| sulphate | | | |
| Hydrated lime | 0.31 | | |
| Welan gum | 0.05 | | |
| Sodium gluconate | 0.15 | | |
| Water | 50.85 | Water | 66.04 |

Example 1 was repeated but with different amounts of the individual ingredients as shown in Table 2. Component A was formed by mixing the ingredients in the same order as described in Example 1. Components A and B were pumpable for at least 24 hours when stored at 15 degrees centigrade under static conditions. Components A and B were mixed together in equal volumes to give a settable composition having water to solids weight ratio of 2.02:1.

The composition was mixed and pumped onto a flexible container as described in Example 1. The uniaxial compressive strength was measured as described in Example 1. The compressive strengths achieved were as follows:

| | | | |
|---|---|---|---|
| 2 | hours | 33 | psi |
| 4 | hours | 190 | psi |
| 24 | hours | 407 | psi |
| 8 | days | 523 | psi; |
| 28 | days | 788 | psi; and |
| 6 | weeks | 874 | psi. |

### Example 3

This Example is according to the invention shows the effect of using an intermediate amount of anhydrite.

TABLE 3

| | % in | | % in |
|---|---|---|---|
| Component A | the mix | Component B | the mix |
| Type III Portland cement | 23.22 | 39% solids sodium silicate | 33.96 |
| Type F Flyash | 23.22 | (3.3:1 weight ratio of | |
| Anhydrite | 2.21 | silica/sodium oxide) | |
| Hydrated lime | 0.31 | | |
| Welan gum | 0.05 | | |
| Sodium gluconate | 0.15 | | |
| Water | 50.84 | Water | 66.04 |

Components A and B were prepared using the amounts of the individual ingredients shown in Table 3. Both components were pumpable after at least 24 hours when stored under static conditions at 15 degrees Centigrade. The components were mixed in equal volumes to give a fluid self levelling settable composition to which additional water could readily be incorporated. The amount of flyash in the composition was 12.75% based on the total weight of A and B. The water to solids weight ratio was 2.02:1. The composition gelled in about 30 seconds.

The composition was pumped into a flexible container as described in Example 1. The compressive strengths were as follows:

| | | | |
|---|---|---|---|
| 8 | days | 662 | psi; |
| 28 | days | 843 | psi; and |
| 6 | weeks | 1045 | psi |

As can be seen by comparing the performance of Examples 1, 2, and 3, Example 3 with an intermediate amount of anhydrite resulted in intermediate strengths.

### Example 4

When the calcium sulphate content is too high massive disruptive internal expansion can occur when a sample is cured under water. The following example suffered this fate after being cured under water for 7 days. When cured in a sealed container the performance was acceptable and no massive disruptive expansion occurred. The strength at 12 weeks was 1174 psi.

TABLE 4

| | % in | | % in |
|---|---|---|---|
| Component A | the mix | Component B | the mix |
| Type III Portland cement | 23.22 | 39% solids sodium silicate | 33.96 |
| Type F Flyash | 18.80 | (3.3:1 weight ratio of | |
| Anhydrite | 6.63 | silica/sodium oxide) | |
| Hydrated lime | 0.31 | | |
| Welan gum | 0.05 | | |
| Sodium gluconate | 0.15 | | |
| Water | 50.84 | Water | 66.04 |

Components A and B were prepared using the amounts of the individual components shown in Table 4.

### Example 5

This used a class C flyash instead of a Type F flyash. The proportions were as follows:

TABLE 5

| | % in | | % in |
|---|---|---|---|
| Component A | the mix | Component B | the mix |
| Type III Portland cement | 22.71 | 39% solids sodium silicate | 33.96 |
| Class C Flyash | 18.39 | (3.3:1 weight ratio of | |
| Anhydrite | 6.49 | silica/sodium oxide) | |
| Hydrated lime | 0.30 | | |
| Welan gum | 0.05 | | |
| Sodium gluconate | 0.15 | | |
| Water | 51.91 | Water | 66.04 |

Components A and B were prepared using the amounts of the individual ingredients shown in Table 5. Both components were pumpable after being stored for at least 24 hours at 15 degrees Centigrade under static conditions. The components were mixed in equal volumes to give a fluid settable composition which was self levelling. The composition had a water to solids weight ratio of 2.07:1. The composition was pumped into a flexible container as described in Example 1.

No massive internal expansion was noted despite being cured under water. The performance was as follows:

| | | | |
|---|---|---|---|
| 7 | days | 754 | psi: |
| 6 | weeks | 1094 | psi; and |
| 12 | weeks | 1280 | psi. |

### Example 6

In this example, a composition A was obtained by dry blending the following ingredients together:

### 200 g Type 1 OPC

40 g anhydrite
160 g Type F flyash
2 g sodium gluconate
0.2 g Jordapon CI powder (sodium cocoyl isethionate)
0.2 g Methocel 228 (hydroxy propyl methyl cellulose)

### 0.2 g Welan gum

The composition A was mixed with 400 g of water with high speed agitation so as to entrain air. This now lightweight (i.e. low density) grout was mixed with a solution B of sodium silicate comprising 200 g of 40 wt % solids sodium silicate (3.3:1 weight ratio of silica/sodium oxide) and 50 g of water. The mixture gelled in 21 seconds at 21° C. At 28 days, the compressive strength as determined by the use of a 4 inch (25.4 mm) cube was 695 psi. The specific gravity of the foamed grout mixture was 0.975.

1. A system comprising two components to be mixed together to form a settable cementitious composition wherein a first component comprises:
(a) Portland cement;
(b) calcium sulphate; and
(c) water in a weight ratio of water to Portland cement and calcium sulphate solids of from 0.5:1 to 5:1; and a second component comprises:
(d) a water soluble silicate; and
(e) water, in a weight ratio of water to silicate solids of from 1.5:1 to 25:1.

2. The system as defined in claim 1 wherein the first component comprises Portland cement in an amount from at least about 6% by weight based on the weight of a settable composition formed by combining the first and second components.

3. The system as defined in claim 1 wherein the first component comprises calcium sulphate in an amount from at least about 0.5% by weight based on the weight of a settable composition formed by combining the first and second components.

4. The system as defined in claim 1 wherein the second component comprises a water soluble silicate in an amount from at least about 2% by weight based on the weight of a settable composition formed by combining the first and second components.

5. The system as defined in claim 1 wherein the first and/or second component comprises a suspension agent to prevent solids settling out.

6. The system as defined in claim 1 wherein the first and/or second component contains a retarder for the cement hydration reaction.

7. The system as defined in claim 1 wherein the first and/or second component contains a gelling agent to provide early stiffness.

8. The system as defined in claim 1 wherein the first component contains a further non-aluminous cement.

9. The system as defined in claim 8 wherein the amount of a further non-aluminous cement is from about 2% by weight based on the weight of a settable composition formed by combining the first and second components.

10. The system as defined in claim 1 wherein a settable composition formed by combining the first and second components has a minimum solids content of at least about 10% by weight of the settable composition.

11. The system as defined in claim 1 wherein a settable composition formed by combining the first and second components has a water to solids weight ratio of at least about 1.2:1.

12. The system as defined in claim 1 wherein the first and/or second component contains a foaming agent.

13. The system as defined in claim 12 wherein the first and/or second component contains a foam stabiliser.

14. (canceled)

15. A settable cementitious composition which is fluid for sufficient time to be suitable for use in a flexible container to provide support in a mine wherein said composition comprises:
(i) Portland cement;
(ii) calcium sulphate;
(iii) a water soluble silicate; and
(iv) water in an amount to provide a water to solids weight ratio of at least about 1.2:1.

16. The settable composition as defined in claim 15 which is formed by combining the by combining the Portland cement and calcium sulphate with water in a weight ratio of water to Portland cement and calcium sulphate solids of from about 0.5:1 to 5:1 and combining the water soluble silicate with water in a weight ratio of water to silicate solids of from about 1.5:1 to 25:1.

17. The settable composition as defined in claim 15 which is foamed

18. A method of producing a settable composition which is fluid for sufficient length of time to be suitable for use in a flexible container for providing support in mine, which method comprises the steps of:
providing a first component comprising Portland cement, calcium sulphate and water in a weight ratio of water to Portland cement and calcium sulphate solids of from 0.5:1 to 5:1, and a second component comprising a water soluble silicate and water in a weight ratio of water to silicate solids of from about 1.5:1 to 25:1; and
mixing the first and second components of the system together to form a settable composition having a water to solids weight ratio of at least about 1.2:1.

19. The method as defined in claim 18 which comprises the step of entraining air in the first and/or second component prior to the step of mixing the first and second components.

20. A method of providing support in a mine which method comprises providing a first component of Portland cement and calcium sulphate and water in a weight ratio of water to Portland cement and calcium sulphate solids of from 0.5:1 to 5:1 and a second component of a water soluble silicate and water in a weight ratio of water to silicate solids of from about 1.5:1 to 25.1 at a point of use in the mine, mixing the components to form a settable composition and employing the settable composition to give support in the mine.
